(19) United States
(12) Patent Application Publication
(10) Pub. No.: US 2008/0055898 A1
(43) Pub. Date: Mar. 6, 2008

(54) Led lamp

(75) Inventor: Jia H. Deng, Diamond Bar, CA (US)

Correspondence Address: FSP LLC, P.O. BOX 890, VANCOUVER, WA, 98666, US

(73) Assignee: DM Technology & Energy Inc., Montclair, CA (US)

(21) Appl. No.: 11/897,245

(22) Filed: Aug. 28, 2007

Related U.S. Application Data
(60) Provisional application No. 60/840,880, filed on Aug. 28, 2006.

(51) Int. Cl. F21V 9/08; F21V 21/00

(52) U.S. Cl. 362/231; 362/249

(57) ABSTRACT

A light source may include and/or involve multiple LEDs arranged at positions in a first vertical plane, and multiple LEDs arranged at positions in a second vertical plane, the positions in the second vertical plane being non-overlapping with the positions in the first vertical plane.

### TECHNICAL FIELD

The present disclosure relates to LED lighting.

### BACKGROUND

Light emitting diodes (LEDs) offer many advantages over other lighting technologies. Among these advantages are longer life, lower cost of ownership, and in some instances lower heat dissipation and more aesthetic color choices.

### SUMMARY

The following summary is intended to highlight and introduce some aspects of the disclosed embodiments, but not to limit the scope of the claims. Thereafter, a detailed description of illustrated embodiments is presented, which will permit one skilled in the relevant art to make and use various embodiments.

A light source may include and/or involve multiple LEDs arranged at positions in a first vertical plane, and multiple LEDs arranged at positions in a second vertical plane, the positions in the second vertical plane being non-overlapping with the positions in the first vertical plane. The LEDs may be arranged around a stem coupled to a base, and/or arranged at four approximately evenly spaced locations around a center point, with the positions in the second vertical plane rotated approximately 45 degrees from the positions in the first vertical plane.

The light source may include and/or involve a glass or transparent plastic enclosure around the LEDs of the first and second vertical planes.

The light source may include and/or involve a base including a corrugated exterior.

A flickering light source may include and/or involve multiple LEDs of a first color, at least one flickering LED of a second color, and the first and second colors combining to create a flickering flame effect. The LEDs may include multiple yellow LEDs, and/or at least one flickering red LED.

The light source may include and/or involve multiple yellow LEDs arranged around at least one flickering red LED. The multiple yellow LEDs arranged around at least one flickering red LED may include and/or involve the at least one flickering red LED elevated above the yellow LEDs.

The light source may include and/or involve an inner transparent surface enclosing the LEDs of the first and second colors. The light source may include and/or involve an outer transparent surface enclosing the inner transparent surface. The inner and outer surfaces may have the approximate shape of a flame.

Other system/method/apparatus aspects are described in the text (e.g., detailed description and claims) and drawings forming the present application.

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is an illustration of an embodiment of a LED light source.

FIG. 2 is an illustration of an embodiment of a LED flicker light source.

FIG. 3 is an illustration of an embodiment of an LED light source having a standard A19 electrical socket interface.

### DETAILED DESCRIPTION

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

LED Light Source

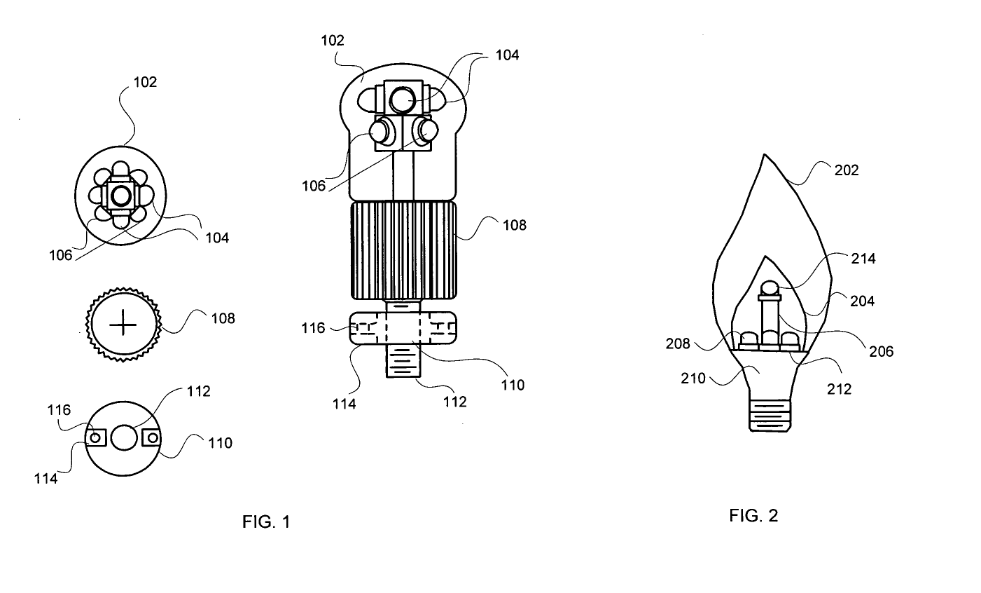

FIG. 1 is an illustration of an embodiment of a LED light source.

The source includes a bulb designed to be screwed into the socket of a regular incandescent light bulb. The light source comprises an enclosing outer bulb a.k.a. surface 102, LEDs 104 on a first vertical plane, LEDs 106 on a second vertical plane, a base 108 including a corrugated exterior, base mounting threads 112, and a mounting base 110. Each LED 104 and 106 also has associated drive electronics. The outer surface 102 usually comprises transparent or semi-transparent material such as glass, and may be referred to herein as the bulb 102.

The base 110 comprises at least two holes 116. The holes 116 have associated supporting material 114 on at least one surface of the base 110 such that they may accept screws to attach the base 110 to something else such as a lighting wiring box. The base 110 may be formed at least in part from ceramic or plastic. The material of the screw supports 114 may consist at least in part of metal or plastic. The base 110 also comprises a hole sized such that the threads 112 may engage the base.

When the LED bulb is viewed upright, meaning that the bulb 102 is at the top and threads 112 at the bottom, it may be seen that the LEDs 104 and 106 are arranged into two vertical planes (other embodiments may comprise LEDs arranged in more than two vertical planes). In the embodiment illustrated, there are four LEDs 104 in the top plane. These LEDs 104, which have associated fittings and control logic, are organized around a central point or post. In this case, adjacent LEDs 104 are sited at right angles (90 degree separation) to one another. The lower plane of LEDs 106 is similarly organized. In addition, looking down from above, it may be seen that the second plane of LEDs 106 has been rotated 45 degrees with respect to the top plane of LEDs 104. As illustrated, each second plane LED 106 is sited at a 45 degree angle from the two adjacent LEDs 104 of the upper plane. This organization may serve to improve the evenness of the light emitted from the bulb. This organization may also improve management of the heat generated by the combined LEDs.

As illustrated, multiple LEDs are arranged at four approximately evenly spaced locations around a center point in each plane. The positions in the second vertical plane are non-overlapping (when viewed from above) with the positions in the first vertical plane, being rotated approximately 45 degrees from the positions in the first vertical plane. In general, a different number of LEDs (other than four) may be employed in each plane, with different angles of relative orientation.

The LEDs will in many implementations emit bright white light, but may in general include non-white light sources.

LED Flicker Light Source

FIG. 2 is an illustration of an embodiment of a LED flicker light source.

The flicker source comprises an outer enclosing surface (outer bulb) 202, an inner enclosing surface (inner bulb) 204, an upper LED 214 of a first color, a shaft 206 which supports the upper LED 214, a collection of lower LEDs 208 of a second color, holders 212 for the lower LEDs 208, and a base area 210 upon which the row of lower LEDs 208 with their holders are mounted, and which may comprise circuitry to drive the LEDs and produce a flicker effect in one or more of them. The light source includes threads so that it may be screwed into the socket of a regular incandescent light bulb.

The upper LED 214 may emit red light and may flicker. The lower row of LEDs 208 may emit yellow light and not flicker, or they may also flicker as well in some embodiments.

In general, the flicker light source may include multiple LEDs of a first color (e.g. yellow), at least one flickering LED of a second color (e.g. red), with the first and second colors combining to create a flickering flame effect. Of course, other color combinations may also be employed to simulate flame of various color and intensity.

The multiple yellow LEDs may be arranged around the at least one flickering red LED, which may be elevated above the yellow LEDs.

An inner transparent surface 204 of glass or other transparent material, and having an approximate flame shape, may enclose the LEDs of the first and second colors. An outer transparent surface 202 may enclose the inner transparent surface, and may also have the approximate shape of a flame.

LED A19 Light Source

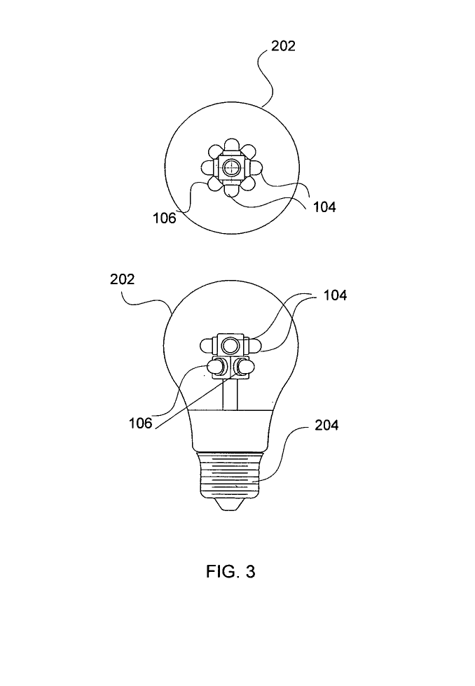

FIG. 3 is an illustration of an embodiment of an LED light source having a standard A19 electrical socket interface.

The light source is packaged as a bulb 202 and an electrical socket interface 204 that are compatible with A19 incandescent sockets. The socket interface 204 comprises LED driver circuitry to convert AC power from an A19 socket to a form suitable for driving the LEDs (e.g. 104, 106).

What is claimed is:

1. A light source comprising:
multiple LEDs arranged at positions in a first vertical plane; and
multiple LEDs arranged at positions in a second vertical plane, the positions in the second vertical plane being non-overlapping with the positions in the first vertical plane.

2. The light source of claim 1, further comprising:
an A19 socket compatible base, the base comprising driver circuitry for the LEDs.

3. The light source of claim 1, wherein the multiple LEDs arranged at positions in a first vertical plane further comprises:
the multiple LEDs arranged around a stem coupled to a base.

4. The light source of claim 1, wherein the multiple LEDs arranged at positions in a first vertical plane further comprises:
multiple LEDs arranged at four approximately evenly spaced locations around a center point.

5. The light source of claim 1, wherein the multiple LEDs arranged at positions in a second vertical plane, the positions in the second vertical plane being non-overlapping with the positions in the first vertical plane further comprises:
the positions in the second vertical plane rotated approximately 45 degrees from the positions in the first vertical plane.

6. The light source of claim 1, wherein the multiple LEDs arranged at positions in a first vertical plane further comprises:
the LEDs comprising at least one of a white light source and a non-white light source.

7. The light source of claim 1, further comprising:
a glass or transparent plastic enclosure around the LEDs of the first and second vertical planes.

8. The light source of claim 1, further comprising:
a base comprising a corrugated exterior.

9. A light source comprising:
multiple LEDs of a first color;
at least one flickering LED of a second color; and
the first and second colors combining to create a flickering flame effect.

10. The light source of claim 9, wherein the multiple LEDs of a first color further comprises: multiple yellow LEDs.

11. The light source of claim 9, wherein the at least one flickering LED of a second color further comprises:
at least one flickering red LED.

12. The light source of claim 9, further comprising:
multiple yellow LEDs arranged around at least one flickering red LED.

13. The light source of claim 12, wherein the multiple yellow LEDs arranged around at least one flickering red LED further comprises:
the at least one flickering red LED elevated above the yellow LEDs.

14. The light source of claim 9, further comprising:
an inner transparent surface enclosing the LEDs of the first and second colors.

15. The light source of claim 9, further comprising:
an outer transparent surface enclosing an inner transparent surface, the inner transparent surface enclosing the LEDs of the first and second colors.

16. The light source of claim 15, wherein the an outer transparent surface enclosing an inner transparent surface, the inner transparent surface enclosing the LEDs of the first and second colors further comprises:
the inner and outer surfaces having an approximate shape of a flame.
